(19) United States
(12) Patent Application Publication
(10) Pub. No.: US 2009/0112354 A1
(43) Pub. Date: Apr. 30, 2009

(54) METHOD OF DETERMINING OPTIMAL PARAMETERS FOR MACHINING A WORKPIECE

(76) Inventors: Tahany Ibrahim El-Wardany, Bloomfield, CT (US); Robert A. Barth, South Windsor, CT (US); John E. Holowczak, S. Windsor, CT (US); William K. Tredway, Manchester, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/928,443

(22) Filed: Oct. 30, 2007

(51) Int. Cl. G06F 19/00; F01D 5/14

(52) U.S. Cl. 700/160; 29/889.23; 700/159; 703/7

(57) ABSTRACT

A method of determining optimal parameters for machining a workpiece comprises performing a first computer simulation to determine parameters for machining a workpiece, including a tool nose radius and a tool rake angle, performing a second computer simulation to determine additional parameters for machining a workpiece, including a tool rotational speed and tool feed speed, and performing a third computer simulation to optimize the parameters for a desired tool path. A method of machining a green or bisque ceramic workpiece contacts the workpiece with a tool using a negative rake angle.

This invention was made with government support under Contract No.: W31P4Q-05-D-R002, Task Order 1 awarded by the Department of the Army. The government may therefore have certain rights in this invention.

### BACKGROUND OF THE INVENTION

This invention relates to machining a workpiece, and more particularly to a method of determining optimal parameters for machining a workpiece, such as a green or bisque ceramic workpiece.

Ceramic materials are commonly used as structural materials. Some example ceramic materials include silicon nitride and silicon carbide. It is possible to machine a ceramic workpiece to form a structure having complex geometric dimensions, such as that of an integrally bladed rotor for a turbine engine. Depending on the state of the ceramic workpiece, different machining techniques may be used. A typical ceramic workpiece begins in the form of a consolidated powder mass, in an unfired state as “green ceramic” and is then partially fired (incompletely sintered) to become “bisque ceramic.” Bisque ceramic workpieces may then be fully hardened in a heating process called “sintering.”

A sintered ceramic workpiece is typically very hard, and machining a sintered workpiece often requires grinding with a diamond or cubic boron nitride tool, which can be a slow and costly process. It is therefore desirable to engage in “green machining” or “bisque machining” to machine a ceramic workpiece in a green or bisque state. Although green and bisque ceramics can be machined at much higher rates than sintered ceramics, green and bisque ceramics may be very brittle and mechanically weak, and therefore can easily crack. Due to the brittle nature of green and bisque ceramics, existing green and bisque machining methods have included point milling, where a tip of a tool is applied to a work piece, but have not included flank milling, where an entire side of a tapered tool tip is applied to a workpiece.

### SUMMARY OF THE INVENTION

A method of determining optimal parameters for machining a workpiece comprises performing a first computer simulation to determine parameters for machining a workpiece, including a tool nose radius and a tool rake angle, performing a second computer simulation to determine additional parameters for machining a workpiece, including a tool rotational speed and tool feed speed, and performing a third computer simulation to optimize the parameters for a desired tool path.

A method of machining a green or bisque ceramic workpiece contacts a tool using a negative rake angle. The method of determining optimal parameters for machining a workpiece is separately patentable from the method of machining a workpiece.

These and other features of the present invention can be best understood from the following specification and drawings, the following of which is a brief description.

### BRIEF DESCRIPTION OF THE DRAWINGS

FIG. 1 schematically illustrates an example workpiece and an example tool.

FIG. 2 schematically illustrates an example machined workpiece.

FIG. 3 schematically illustrates an example tool.

FIG. 3a schematically illustrates a nose radius and helix angle of the tool of FIG. 3.

FIG. 4 schematically illustrates in block diagram form an example method of determining optimal parameters for machining a workpiece.

FIG. 5a schematically illustrates an example positive rake angle and a first heat distribution.

FIG. 5b schematically illustrates an example negative rake angle and a second heat distribution.

### DETAILED DESCRIPTION OF THE PREFERRED EMBODIMENT

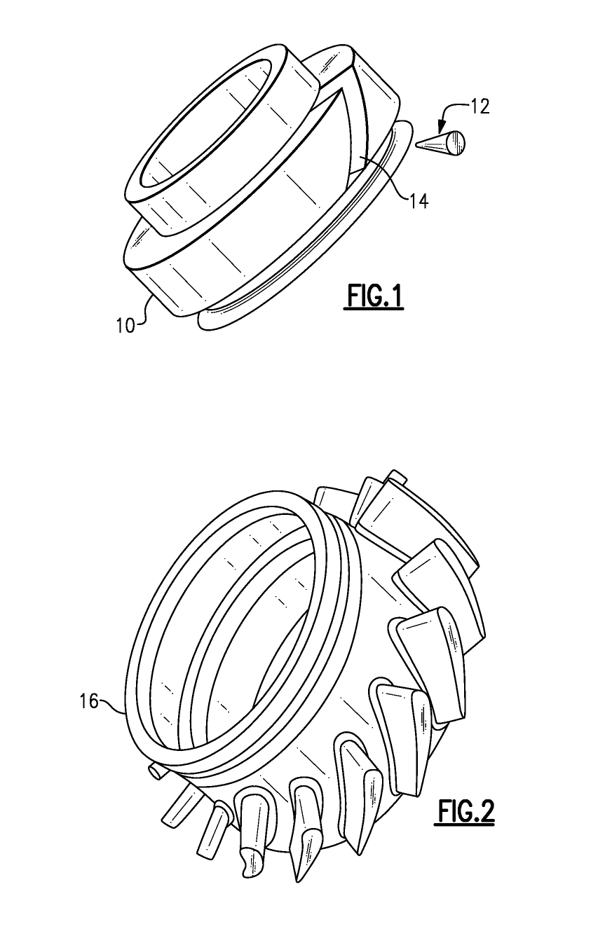

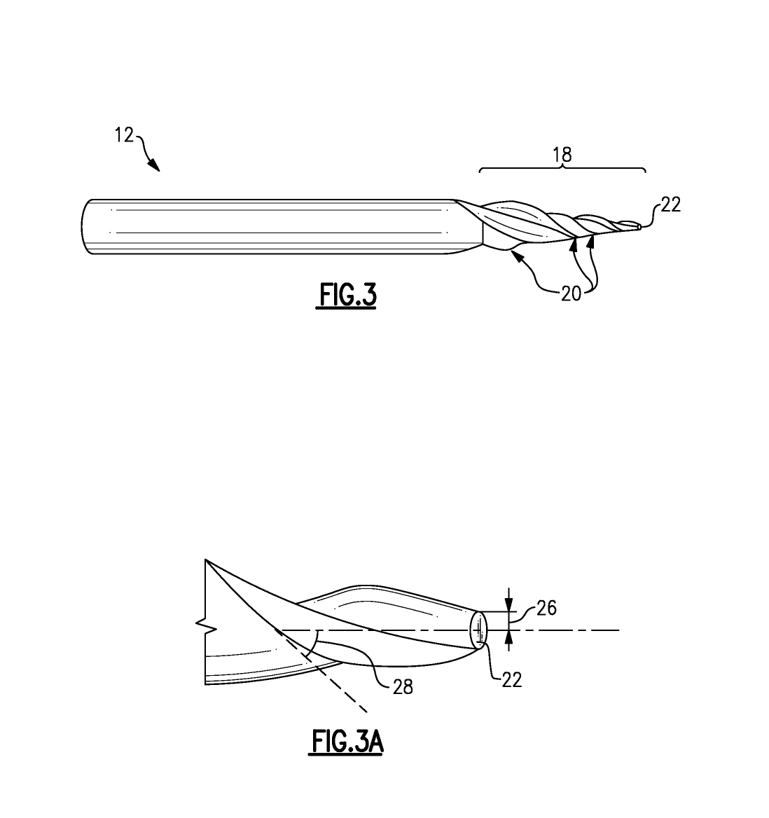

FIG. 1 schematically illustrates an example workpiece 10 and an example tool 12. The tool 12 may be rotated and applied to the workpiece to form a groove 14 in the workpiece. This process may be repeated until the workpiece 10 is formed into a structure, such as an integrally bladed rotor 16 as shown in FIG. 2. In one example the workpiece 10 is a green or bisque ceramic workpiece.

FIG. 3 schematically illustrates the example tool 12 that may be used to machine a workpiece. The tool 12 has a helix 20 and a tapered tip 18 including a nose 22. FIG. 3a schematically illustrates that the nose 22 of the tool has a nose radius 26, and that the helix 20 has a helix angle 28. In one example, an entire length of the tapered tip 18 is applied to a workpiece to perform a flank milling function.

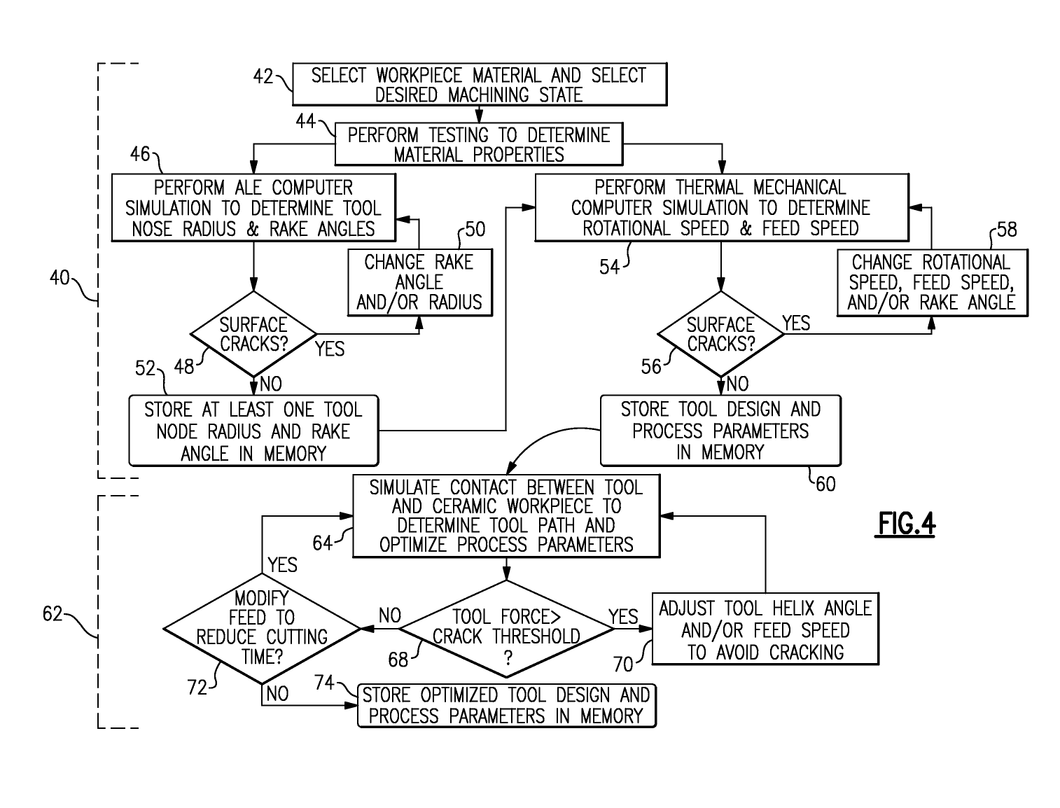

FIG. 4 schematically illustrates in block diagram form an example method of determining processing parameters for machining a workpiece. A first part 40 of the method determines a plurality of machining parameters, and a second part 62 of the method optimizes those parameters for a desired tool path. In a step 42 a workpiece material and a desired machining state are selected. In one example the workpiece material is a ceramic material, and the machining state is a green or bisque state. However, it is understood that other workpiece materials in other states could be used. In a step 44 the workpiece material is tested to determine properties of the workpiece material in the desired machining state. Some example properties that may be determined include tensile strength, elastic modulus, bending strength, and crack propagation criteria. Some example crack propagation criteria include fracture toughness and work of fracture. In one example the step 44 involves testing based on the ASTM-C-1499-03 standard. However, it is understood that step 44 would not be necessary if the properties of the workpiece material in the desired state were already known.

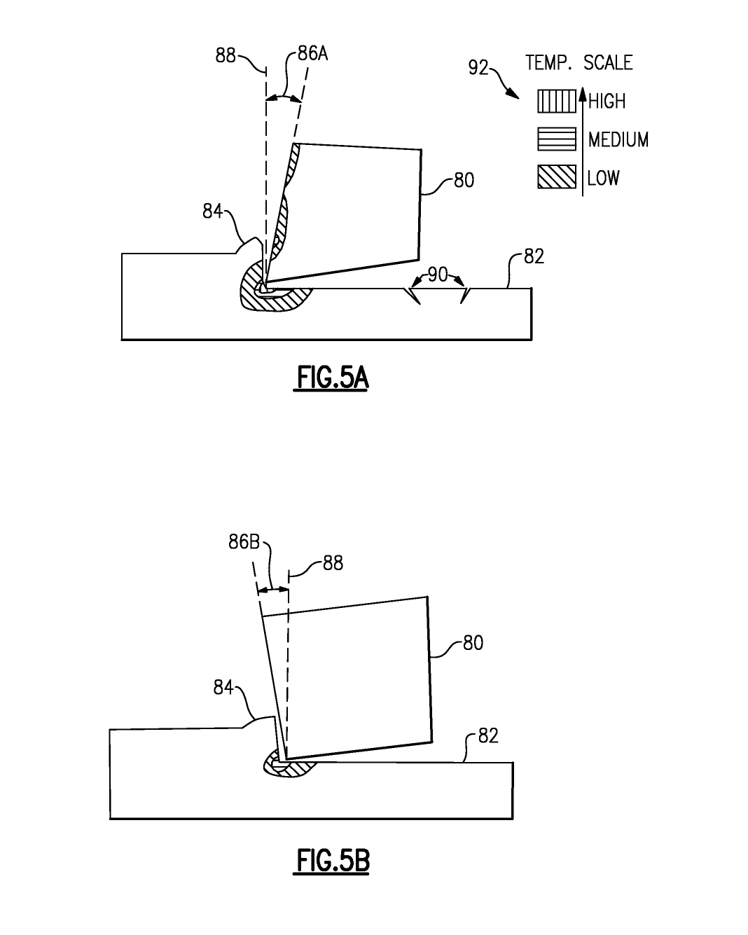

In a step 46, a first computer simulation is performed to determine parameters for machining a workpiece, including a tool nose radius and a tool rake angle. In one example the tool rake angle is a negative rake angle. A rake angle is an angle formed between a tip of a machining tool and a workpiece. FIG. 5a schematically illustrates an example positive rake angle 86a. As shown in FIG. 5a, a tool 80 is applied to a workpiece 82 to remove material 84 from the workpiece. An angle 86a having a positive value is formed between a tip of the tool 80 and an axis 88 that is perpendicular to the workpiece 82. FIG. 5b also schematically illustrates an example negative rake angle 86b. In the example of FIG. 5b the angle 86 formed between the tip of the tool 80 and the axis 88 has a negative value.

FIG. 5a also schematically illustrates a temperature scale 92 which indicates high temperatures with vertical lines, medium temperatures with horizontal lines, and lower temperatures with diagonal lines. As shown in FIGS. 5a and 5b, the positive rake angle of FIG. 5a results in a hotter tool and work piece than the negative rake angle of FIG. 5b. The positive rake angle may also undesirably causes the formation of cracks 90 on the surface of the workpiece 82, while fewer, or no cracks are formed with the negative rake angle in FIG. 5b. It may therefore be desirable to select a negative rake angle in step 46 to prevent the formation of cracks on the surface of a workpiece, and to prevent a tool and workpiece from becoming excessively hot.

Once a tool nose radius and rake angle are selected, step 46 then simulates contact between a computer model of a tool and a computer model of a workpiece, wherein the tool has a selected nose radius, the ceramic workpiece has the properties determined in step 44, and the tool contacts the workpiece at a selected rake angle. In one example the computer simulation of step 46 includes simulating contact between an entire side of a tapered tool tip and the workpiece so that the tool performs a flank milling function. Step 46 determines if the selected nose radius and rake angle will cause any cracks on a surface of the workpiece. In one example, the computer simulation performed in step 46 is an Arbitrary Lagrangian and Eulerian (“ALE”) finite element simulation that may be performed using software such as ABAQUS.

In a step 48 a check is performed to see if cracks have been formed on the workpiece in the computer simulation of step 46. If cracks have been formed, in a step 50 at least one of the rake angle and tool edge radius are adjusted, and the computer simulation of step 46 is performed again. Steps 48 and 50 may be repeated until no cracks are formed on the workpiece surface in the computer simulation. Once no cracks are formed, the tool nose radius and tool rake angle from step 46 are stored in memory in a step 52. In one example a single tool nose radius and tool rake angle are saved to memory in step 52. In another example, a plurality of tool nose radii and tool rake angles are stored in step 52.

A second computer simulation is then performed in a step 54 to determine additional parameters for machining a workpiece, including a tool rotational speed and a tool feed speed. A feed speed of a tool refers to a speed at which the tool is moved across a surface of a workpiece. The second computer simulation simulates contact between a tool and a workpiece by applying a tool having a nose radius from step 52 to a workpiece having the material properties from step 44 at a rake angle from step 52. The computer simulation of step 54 rotates the tool at a selected rotational speed and moves the tool at a selected feed speed. In one example the computer simulation of step 52 includes simulating contact between an entire side of a tapered tool tip and the workpiece so that the tool performs a flank milling function. In one example the second computer simulation is a finite element simulation using a coupled thermal mechanical analysis with an updated Lagrangian formulation. In one example the second computer simulation may be performed using software such as ABAQUS. Some additional example parameters that may be selected and tested in step 54 include a tool material, and a tool coating.

In the computer simulation of step 54, a maximum stress that may be applied to a workpiece without cracking the workpiece may be used to predict workpiece cracking. The maximum stress is a function of strain, strain rate, and temperate, as shown by the equation below:

Σ=f(ε,εₚₗ,t) equation #1

where Σ is maximum stress,
ε is a strain;
εₚₗ is a strain rate; and
t is a temperature.

In a step 56 a check is performed to determine if a tool rotational speed and feed speed coupled with a tool nose radius and rake angle from step 52 cause any cracks on a surface of the computer model of the workpiece. If cracks are formed, in a step 58 at least one of the tool rotational speed, tool feed speed, or rake angle are adjusted, and the computer simulation of step 54 is repeated. However, it is understood that other parameters could be altered. Steps 56 and 58 may be repeated until no cracks are formed on the workpiece surface in the computer simulation. Once no cracks are formed, the tool rotational speed, tool feed speed, and tool rake angle are stored in memory in a step 60. In one example a single tool rotational speed, tool feed speed, and tool rake angle are saved to memory in step 60. In another example, a plurality of tool rotational speeds, tool feed speeds, and tool rake angles are stored in step 60.

As mentioned above, the second part 62 of the method of FIG. 4 optimizes the parameters from steps 52 and 60 for a desired workpiece tool path. In a step 64 a third computer simulation is performed to optimize the parameters of steps 52 and 60. The third computer simulation simulates contact between a tool and a workpiece along a selected tool path to determine a magnitude of at least one force applied by the tool to the workpiece and to verify that the at least one force applied by the tool does not exceed a crack threshold of the workpiece. In one example the computer simulation of step 64 includes simulating contact between an entire side of a tapered tool tip and the workpiece so that the tool performs a flank milling function. In one example the third computer simulation includes using a mechanistic model. Software such as ABAQUS may be used to perform the third simulation. In one example, one of the at least one forces is an exit force applied by the tool to the workpiece when the tool has completed forming a groove 14 in the workpiece.

In a step 68, a check is performed to determine if the at least one force applied by the tool to the workpiece exceeds a workpiece crack threshold. If the at least one force exceeds the crack threshold, then the machining parameters may be altered in a step 70. In the step 70 at least one of the tool helix angle 28 or the tool feed speed are altered, and the third computer simulation is repeated in step 64. However, it is understood that other machining parameters could also be altered. Steps 68 and 70 may be repeated until no cracks are formed on the workpiece surface in the third computer simulation

If forces applied by the tool do not exceed the crack threshold, then a decision is made in a step 72 whether to complete the parameter optimization or whether to modify the parameters. While it is desirable to ensure that the tool forces to not exceed the workpiece crack threshold, it is also desirable to increase a tool feed speed to maximize efficiency of a machining process. Thus, it may be desirable to increase the tool feed speed and then repeat the third computer simulation in step 64. In one example the tool feed speed is repeatedly increased so that the forces applied by the tool are just beneath the workpiece crack threshold. Once the tool feed speed has been sufficiently increased, or is deemed to be acceptable, then in a step 74 the optimized parameters for machining a workpiece are stored in memory.

A method of machining a green or bisque ceramic workpiece comprises contacting a tool having the nose radius from the computer simulation of step 46 to a workpiece using a negative rake angle, tool rotational speed, and tool feed speed from the computer simulations of steps 46, 54, and 64. In one example a workpiece material of the workpiece corresponds to the workpiece material selected in step 42.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of determining optimal parameters for machining a workpiece, comprising:
1) performing a first computer simulation to determine parameters for machining a workpiece, including a tool nose radius and a tool rake angle;
2) performing a second computer simulation to determine additional parameters for machining a workpiece, including a tool rotational speed and tool feed speed; and
3) performing a third computer simulation to optimize the parameters for a desired tool path.

2. The method of claim 1, further including:
4) determining a tensile strength and a crack propagation criteria of a selected workpiece material, wherein the selected workpiece material is a green or bisque ceramic.

3. The method of claim 2, wherein step 4 is performed before steps 1-3.

4. The method of claim 1, wherein step 1) includes:
a) selecting a tool nose radius and a rake angle;
b) simulating contact between a computer model of a tool and computer model of a workpiece, wherein the tool has the selected nose radius and the tool contacts the workpiece at the selected rake angle; and
c) making a change in a selected criteria, and then repeating steps (a)-(b) in response to formation of cracks on the computer model of the work piece.

5. The method of claim 4, wherein the selected rake angle is a negative rake angle.

6. The method of claim 4, wherein step b) includes performing an arbitrary Lagrangian-Eulerian finite element simulation.

7. The method of claim 1, wherein step 2) includes:
a) selecting a tool rotational speed and a tool feed speed;
b) simulating contact between a computer model of a tool and a computer model of a workpiece, wherein the tool has the nose radius of step 1) and contacts the workpiece at the rake angle of step 1), and wherein the tool rotates at the selected rotational speed and moves at the selected feed speed; and
c) making a change in a selected criteria, and then repeating steps (a)-(b) in response to formation of cracks on the computer model of the work piece.

8. The method of claim 7, wherein step b) includes performing a coupled thermal mechanical analysis with a Lagrangian formulation.

9. The method of claim 1, wherein step 3) includes:
simulating contact between a tool and a workpiece; and
verifying that at least one force applied by the tool does not exceed a workpiece crack threshold.

10. The method of claim 9, further including the steps of:
increasing the feed speed in response to the at least one force applied by the tool not exceeding the workpiece crack threshold.

11. The method of claim 9, further including the steps of:
selectively altering at least one of a tool helix angle and the tool speed feed in response to the at least one force applied by the tool exceeding the workpiece crack threshold.

12. The method of claim 1, wherein the computer simulations include simulating contact between an entire side of a tapered tool tip and a workpiece.

13. A method of machining a green or bisque ceramic workpiece, comprising:
forming a tool; and
contacting a green or bisque ceramic workpiece with the tool, using a negative rake angle.

14. The method of claim 13, including the steps of
1) performing a first computer simulation to determine parameters for machining the workpiece, including a tool nose radius and the negative tool rake angle;
2) performing a second computer simulation to determine additional parameters for machining the workpiece, including a tool rotational speed and tool feed speed; and
3) performing a third computer simulation to optimize the parameters of steps 1-2 for a desired tool path;
4) contacting the tool having the nose radius of steps 1-3 with the green or bisque ceramic workpiece at the negative rake angle of steps 1-3;
5) rotating the tool at the rotational speed of steps 2-3; and
6) moving the tool at the feed speed of steps 2-3.

15. The method of claim 14, wherein step 1) includes:
a) selecting a tool nose radius and a negative rake angle;
b) simulating contact between a computer model of a tool and computer model of a green or bisque ceramic workpiece, wherein the tool has the selected nose radius and the tool contacts the workpiece at the selected negative rake angle; and
c) making a change in a selected criteria, and then repeating steps (a)-(b) in response to formation of cracks on the computer model of the work piece.

16. The method of claim 15, wherein step b) includes performing an arbitrary Lagrangian-Eulerian finite element simulation.

17. The method of claim 14, wherein step 2) includes:
a) selecting a tool rotational speed and a tool feed speed;
b) simulating contact between a computer model of a tool and a computer model of a green or bisque ceramic workpiece, wherein the tool has the nose radius of step 1) and contacts the workpiece at the negative rake angle of step 1), and wherein the tool rotates at the selected rotational speed and moves at the selected feed speed; and
c) making a change in a selected criteria, and then repeating steps (a)-(b) in response to formation of cracks on the computer model of the work piece.

18. The method of claim 17, wherein step b) includes performing a coupled thermal mechanical analysis with a Lagrangian formulation.

19. The method of claim 14, wherein step 3) includes:
simulating contact between a tool and a green or bisque ceramic workpiece; and
verifying that at least one force applied by the tool does not exceed a workpiece crack threshold.

20. The method of claim 19, further including the steps of:
increasing the feed speed in response to the at least one force applied by the tool not exceeding the workpiece crack threshold.

21. The method of claim 19, further including the steps of:
selectively altering at least one of a tool helix angle and the tool feed speed in response to the at least one force applied by the tool exceeding the workpiece crack threshold.

22. The method of claim 14, wherein the computer simulations include simulating contact between an entire side of a tapered tool tip and a workpiece, and wherein step 4) includes contacting an entire side of a tapered tool tip with the workpiece.
